(19) United States
(12) Patent Application Publication
(10) Pub. No.: US 2009/0085885 A1
(43) Pub. Date: Apr. 2, 2009

(54) TOUCH PANEL AND MANUFACTURING METHOD THEREOF

(75) Inventors: Yuan-Chun Wu, Hsinchu (TW); Hsin-Hung Lee, Hsinchu (TW); Mei-Sheng Ma, Hsinchu (TW); Tun-Chun Yang, Hsinchu (TW); Seok-Lyul Lee, Hsinchu (TW); Yao-Jen Hsieh, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/132,625

(22) Filed: Jun. 4, 2008

(30) Foreign Application Priority Data
Sep. 29, 2007 (TW) 96136550

(51) Int. Cl. G06F 3/041

(52) U.S. Cl. 345/173

(57) ABSTRACT

A touch panel and a manufacturing method thereof are provided. The touch panel has a double-layered sensing pad structure or a single-layered sensing pad structure. In the double-layered sensing pad structure, the sensing pads in each layer have corresponding dummy sensing pads in the other layer for compensating the difference of transmittance. In the single-layered sensing pad structure, the sensing pads are coplanar so that the problem of color shift can be overcome and the visual effect of the touch panel can be improved.

### CROSS-REFERENCE TO RELATED APPLICATION

This application claims the priority benefit of Taiwan application serial no. 96136550, filed on Sep. 29, 2007. The entirety of the above-mentioned patent application is hereby incorporated by reference herein and made a part of specification.

### BACKGROUND OF THE INVENTION

1. Field of the Invention

The present invention generally relates to a touch panel and a manufacturing method thereof, in particular, to a touch panel having improved visual effect and a manufacturing method thereof.

2. Description of Related Art

Along with the development of electronics industry, the designs of digital products, such as mobile phones, personal digital assistants (PDAs), notebook computers, and tablet computers, are all going towards convenience, multi-functionality, and attractive appearance. The displays of these digital products are the most indispensable communication interfaces which allow users of these products to operate them conveniently. Among all the displays, liquid crystal display (LCD) has become the mainstream of today's display market.

In recent years, along with the development of information and wireless communication technologies and the widespread of various information products, the conventional input devices (for example, keyboards or mousse) of many information products have been replaced by touch panels in order to make these information products more convenient, small-sized, light-weighted, and personalized, wherein touch panel LCD is the most commonly adopted product.

FIGS. 1A-1C illustrate a conventional touch panel, wherein FIG. 1A is a 3-dimensional view of the touch panel, FIG. 1B is a perspective view of the touch panel, and FIG. 1C is a cross-sectional view of the touch panel. For the convenience of description, FIG. 1A and FIG. 1B illustrate only the sensing pad structure in the touch panel, while FIG. 1C illustrates some other layers, such as a substrate and other dielectric layers, of the touch panel.

As shown in FIGS. 1A-1C, the conventional touch panel 100 includes a substrate 110, a plurality of first sensing serials 120, a first dielectric layer 130, a plurality of second sensing serials 140, and a second dielectric layer 150. To be specific, the first sensing serials 120 are disposed on the substrate 110 and extended along a first direction, wherein each of the first sensing serials 120 is composed of a plurality of first sensing pads 122 and a plurality of first bridging lines 124 which are connected in series. The first dielectric layer 130 is disposed on the substrate 110 and covers the first sensing serials 120. The second sensing serials 140 are disposed on the first dielectric layer 130 and extended along a second direction, wherein each of the second sensing serials 140 is composed of a plurality of second sensing pads 142 and a plurality of second bridging lines 144 which are connected in series. The projections of the first sensing pads 122 and the second sensing pads 142 form a sensing array on the substrate 110 so as to achieve planar sensing.

As described above, when a user touches the touch panel 100 with a finger, the first sensing pads 122 and the second sensing pads 142 of the touch panel 100 produce an electrical change (for example, a voltage drop or a current change) at where the finger touches the touch panel 100. The electrical change is transformed into a control signal and transmitted to a control circuit board. A central processing unit (CPU) carries out data processing and calculations according to the control signal, and then the control circuit board outputs a display signal to a display device and thereby to display image by the display device.

However, in foregoing conventional touch panel, the sensing pads are disposed in different layers therefore may have different characteristics (for example, different transmittances) due to variations in subsequent fabrication processes. Moreover, the transmittance uniformity of the entire touch panel may also be affected by the positions of the sensing pads or the light distance difference of reflected lights since the sensing pads are disposed in different layers. All of foregoing facts may cause the problem of color shift in the touch panel.

On the other hand, when the touch panel is integrated with a display device, a user can easily become aware of the sensing pads in the touch panel, and the difference between those areas disposed with and without sensing pads can be very obvious. Thereby, how to improve the transmittance uniformity of a touch panel and accordingly improve the visual effect thereof is currently one of the major subjects in the manufacturing of touch panels.

### SUMMARY OF THE INVENTION

Accordingly, the present invention is directed to a touch panel, wherein the problem of color shift is effectively overcome and accordingly the visual effect of the touch panel is improved.

The present invention is directed to a touch panel having good transmittance, and a good display quality can be achieved when the touch panel is applied in a display device.

The present invention is also directed to a method for manufacturing a touch panel.

The present invention provides a touch panel including a substrate, at least one first sensing serial, and at least one second sensing serial. The first sensing serial is disposed on the substrate and extended along a first direction. The first sensing serial includes a plurality of first sensing pads and a plurality of first bridging lines, wherein each of the first bridging lines connects adjacent two first sensing pads in series. The second sensing serial is disposed on the substrate and extended along a second direction, wherein the first direction intersects the second direction. The second sensing serial includes a plurality of second sensing pads and a plurality of second bridging lines, wherein the first sensing pads are coplanar to the second sensing pads, and each of the second bridging lines connects adjacent two second sensing pads in series.

According to an embodiment of the present invention, the touch panel further includes a first dielectric layer and a plurality of via holes. The first dielectric layer is disposed on the substrate and covers the first sensing serial and the second sensing pads, and the second bridging lines are located on the first dielectric layer. The via holes are disposed in the first dielectric layer, and the second bridging lines are connected to the corresponding second sensing pads through the corresponding via holes. In addition, the touch panel may further include a second dielectric layer disposed on the first dielectric layer and covering the first sensing serial and the second sensing serial.

According to an embodiment of the present invention, the touch panel further includes a first dielectric layer. The first dielectric layer is disposed on the substrate and covers the first sensing serial, and the first dielectric layer has a plurality of openings corresponding to the second sensing pads. The second sensing pads are located in the corresponding openings, and each of the second bridging lines spans over the first dielectric layer between adjacent two openings and connects the corresponding adjacent two second sensing pads. In addition, the touch panel may further include a second dielectric layer disposed on the first dielectric layer and covering the first sensing serial and the second sensing serial.

According to an embodiment of the present invention, the touch panel further includes a first dielectric layer and a plurality of via holes. The first dielectric layer is disposed on the substrate and covers the first bridging lines, and the first sensing pads and the second sensing serial are located on the first dielectric layer. The via holes are disposed in the first dielectric layer, and the first sensing pads are connected to the corresponding first bridging lines through the corresponding via holes. In addition, the touch panel may further include a second dielectric layer disposed on the first dielectric layer and covering the first sensing serial and the second sensing serial.

According to an embodiment of the present invention, the touch panel further includes a plurality of dummy patterns, wherein each of the dummy patterns is located between a first sensing pad and an adjacent second sensing pad. Each of the dummy patterns may be in strip shape.

According to an embodiment of the present invention, each of the first sensing pads and each of the second sensing pads may respectively have at least one opening for forming a hollow portion, and the hollow portion may include a trellis pattern or a plurality of strip patterns.

The present invention also provides a touch panel including a substrate, at least one first sensing serial, a first dielectric layer, at least one second sensing serial, a second dielectric layer, a plurality of first dummy sensing pads, and a plurality of second dummy sensing pads. The first sensing serial is disposed on the substrate and extended along a first direction. The first sensing serial includes a plurality of first sensing pads and a plurality of first bridging lines, wherein each of the first bridging lines connects adjacent two first sensing pads in series. The second dummy sensing pads are disposed on the substrate. The first dielectric layer is disposed on the substrate and covers the first sensing serial and the second dummy sensing pads. The second sensing serial is disposed on the substrate and extended along a second direction, wherein the first direction intersects the second direction, and the first sensing serial and the second sensing serial are located on different planes. The second sensing serial includes a plurality of second sensing pads and a plurality of second bridging lines, wherein each of the second bridging lines connects adjacent two second sensing pads in series. The first dummy sensing pads are disposed on the first dielectric layer and are corresponding to the first sensing pads. The second dielectric layer is disposed on the first dielectric layer and covers the second sensing serial and the first dummy sensing pads.

According to an embodiment of the present invention, the touch panel further includes a plurality of first dummy patterns, wherein each of the first dummy patterns is located between a first sensing pad and an adjacent second dummy sensing pad. In addition, the touch panel may further include a plurality of second dummy patterns, wherein each of the second dummy patterns is located between a first dummy sensing pad and an adjacent second sensing pad. The first dummy patterns or the second dummy patterns may be in strip shape.

The present invention further provides a method for manufacturing a touch panel. First, a substrate is provided, and at least one first sensing serial and at least one second sensing serial are formed on the substrate. The first sensing serial is disposed on the substrate and extended along a first direction, and the second sensing serial is disposed on the substrate and extended along a second direction, wherein the first direction intersects the second direction. The first sensing serial includes a plurality of first sensing pads and a plurality of first bridging lines, wherein each of the first bridging lines connects adjacent two first sensing pads in series. The second sensing serial includes a plurality of second sensing pads and a plurality of second bridging lines, wherein the second sensing pads are coplanar to the first sensing pads, and each of the second bridging lines connects adjacent two second sensing pads in series.

According to an embodiment of the present invention, foregoing manufacturing method may include following steps. First, the first sensing pads, the first bridging lines, and the second sensing pads are formed on the substrate to make the first sensing pads, the first bridging lines, and the second sensing pads to be coplanar. After that, a first dielectric layer is further formed on the substrate to cover the first sensing pads, the first bridging lines, and the second sensing pads. Besides, a plurality of via holes are formed in the first dielectric layer, and then the second bridging lines are formed on the first dielectric layer, so that the second bridging lines can be connected to the corresponding second sensing pads through the corresponding via holes.

According to an embodiment of the present invention, the manufacturing method may include following steps. First, the first sensing serial is formed on the substrate. After that, a first dielectric layer is further formed on the substrate to cover the first sensing serial. Besides, a plurality of openings are formed in the first dielectric layer, and then the second sensing serial is formed, wherein the second sensing pads of the second sensing serial are formed in the corresponding openings to be coplanar to the first sensing pads, and each of the second bridging lines of the second sensing serial spans over the first dielectric layer between adjacent two openings to connect corresponding adjacent two second sensing pads.

According to an embodiment of the present invention, the manufacturing method may include following steps. First, the first bridging lines are formed on the substrate. After that, a first dielectric layer is further formed on the substrate to cover the first bridging lines. Besides, a plurality of via holes are formed in the first dielectric layer, and then the first sensing pads and the second sensing serial are formed on the first dielectric layer, wherein the first sensing pads, the second sensing pads, and the second bridging lines are coplanar, and the first sensing pads are connected to the corresponding first bridging lines through the corresponding via holes.

According to an embodiment of the present invention, the manufacturing method may further include forming a second dielectric layer on the first dielectric layer to cover the first sensing serial and the second sensing serial.

According to an embodiment of the present invention, the manufacturing method may further include forming a plurality of dummy patterns while forming the first sensing pads or the second sensing pads, wherein each of the dummy patterns is located between a first sensing pad and an adjacent second sensing pad.

According to an embodiment of the present invention, the manufacturing method may further include respectively forming at least one opening in each of the first sensing pads and each of the second sensing pads so as to form a hollow portion.

The present invention further provides a method for manufacturing a touch panel. First, a substrate is provided. Next, a plurality of first sensing pads, a plurality of first bridging lines, and a plurality of second dummy sensing pads are formed on the substrate, wherein each of the first bridging lines connects adjacent two first sensing pads in series to form at least one first sensing serial, and the first sensing serial is extended along a first direction. After that, a first dielectric layer is formed on the substrate to cover the first sensing pads, the first bridging lines, and the second dummy sensing pads. Next, a plurality of second sensing pads, a plurality of second bridging lines, and a plurality of first dummy sensing pads are formed on the first dielectric layer, wherein each of the second bridging lines connects adjacent two second sensing pads in series to form at least one second sensing serial, and the second sensing serial is extended along a second direction, and the second direction intersects the first direction. The first dummy sensing pads are corresponding to the first sensing pads, and the second sensing pads are corresponding to the second dummy sensing pads. After that, a second dielectric layer is formed on the first dielectric layer to cover the second sensing pads, the second bridging lines, and the first dummy sensing pads.

According to an embodiment of the present invention, the manufacturing method may further include forming a plurality of first dummy patterns while forming the first sensing pads, the first bridging lines, and the second dummy sensing pads, wherein each of the first dummy patterns is located between a first sensing pad and an adjacent second dummy sensing pad. In addition, the manufacturing method may further include forming a plurality of second dummy patterns while forming the second sensing pads, the second bridging lines, and the first dummy sensing pads, wherein each of the second dummy patterns is located between a second sensing pad and an adjacent first dummy sensing pad.

According to the present invention, in a touch panel having a double-layered sensing pad structure, dummy sensing pads are disposed on each layer corresponding to the sensing pads on the other layer for compensating the color shift of the touch panel and to improve the visual effect thereof. Additionally, according to the present invention, the sensing pads may also be formed on the same plane so as to form a touch panel having a single-layered sensing pad structure, and various patterns for connecting the sensing pads in different directions are provided. Since the sensing pads are all disposed on the same plane, the problem of color shift is avoided and the display uniformity of the entire touch panel is improved. On the other hand, in the present invention, dummy patterns may be disposed between adjacent sensing pads in order to further improve the visual effect of the touch panel; Or, at least one opening may be formed on each sensing pad to form a hollow portion on the sensing pad so that the visual effect of the touch panel, and accordingly the transmittance thereof, can be further improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1C illustrate a conventional touch panel.

FIGS. 2A-2C illustrate a touch panel according to an embodiment of the present invention.

FIGS. 3A-3D illustrate a manufacturing method of a touch panel according to an embodiment of the present invention.

FIGS. 4A-4C illustrate a touch panel according to another embodiment of the present invention.

FIG. 5 illustrates a single-layered sensing pad structure of a touch panel according to an embodiment of the present invention.

FIGS. 6A-6B, 7A-7B, and 8A-8C illustrate a manufacturing method of a touch panel having a single-layered sensing pad structure according to an embodiment of the present invention.

FIGS. 9A-9B, 10A-10B, and 11A-11C illustrate a manufacturing method of a touch panel having a single-layered sensing pad structure according to another embodiment of the present invention.

FIGS. 12A-12B, 13A-13B, and 14A-14C illustrate a manufacturing method of a touch panel having a single-layered sensing pad structure according to yet another embodiment of the present invention.

FIG. 15 illustrates a touch panel and the relative positions of the sensing pads and dummy patterns thereof according to an embodiment of the present invention.

FIG. 16 illustrates a touch panel and the sensing pads thereof which are disposed with openings according to another embodiment of the present invention.

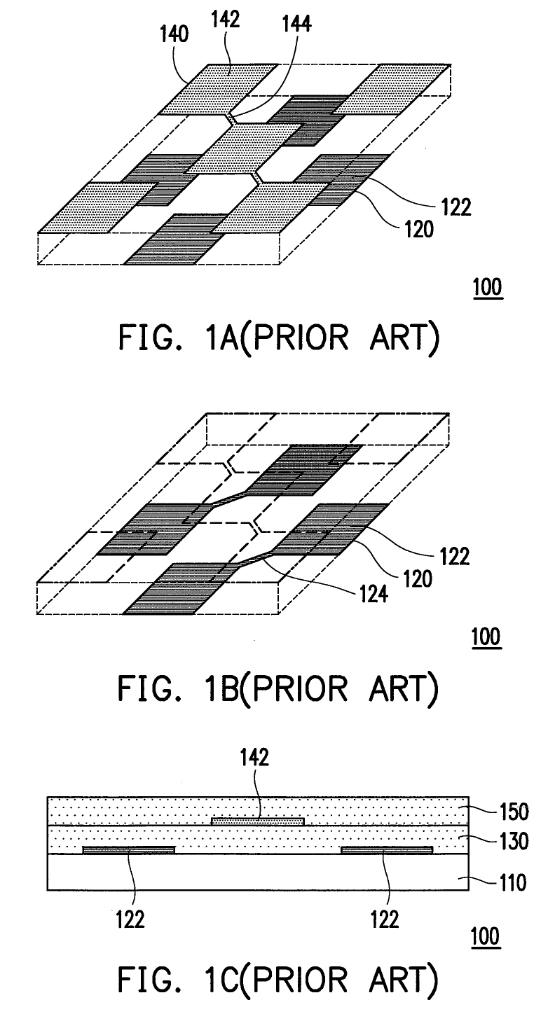

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

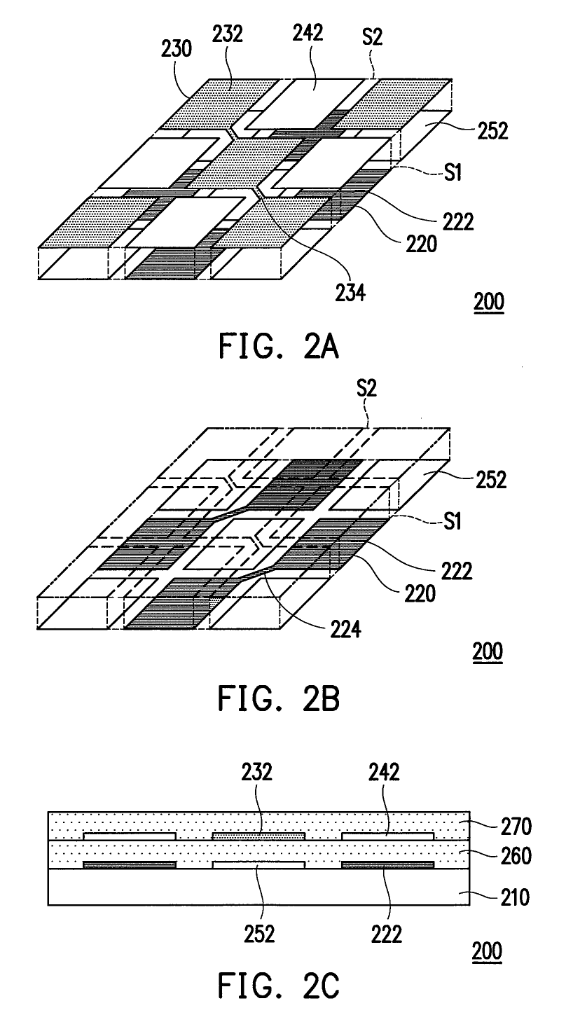

FIGS. 2A-2C illustrate a touch panel according to an embodiment of the present invention, wherein FIG. 2A is a 3-dimensional view of the touch panel, FIG. 2B is a perspective view of the touch panel, and FIG. 2C is a cross-sectional view of the touch panel. For the convenience of description, FIG. 2A and FIG. 2B illustrate only the sensing pad structure in the touch panel, while FIG. 2C illustrates some other layers, such as a substrate and other dielectric layers, of the touch panel.

Referring to FIGS. 2A-2C, in the present embodiment, the touch panel 200 has a double-layered sensing pad structure and which includes a substrate 210, a first sensing serial 220, a second sensing serial 230, a plurality of first dummy sensing pads 242, and a plurality of second dummy sensing pads 252, wherein the numbers of the first sensing serial 220 and the second sensing serial 230 may be one or multiple according to the actual requirement (for example, the size of the touch panel 200). The material of the substrate 210 may be an inorganic or organic transparent material, such as glass or plastic. The first sensing serial 220 is located on a first plane S1 on the substrate 210, and the second sensing serial 230 is located on a second plane S2 on the substrate 210. The first sensing serial 220 and the second sensing serial 230 are respectively extended in two different directions, wherein these two directions intersect, for example, vertically.

The first sensing serial 220 includes a plurality of first sensing pads 222 and a plurality of first bridging lines 224, wherein each of the first bridging lines 224 connects adjacent two first sensing pads 222 in series. The second sensing serial 230 includes a plurality of second sensing pads 232 and a plurality of second bridging lines 234, wherein each of the second bridging lines 234 connects adjacent two second sensing pads 232 in series. The first dummy sensing pads 242 are coplanar to the second sensing pads 232 and the second bridging lines 234 and are corresponding to the first sensing pads 222. The second dummy sensing pads 252 are coplanar to the first sensing pads 222 and the first bridging lines 224 and are corresponding to the second sensing pads 232.

As described above, the present embodiment provides a touch panel having a double-layered sensing pad structure, wherein dummy sensing pads are disposed on each layer corresponding to the sensing pads on the other layer. For example, the first dummy sensing pads 242 are disposed on the second plane S2 corresponding to the first sensing pads 222, and the second dummy sensing pads 252 are disposed on the first plane S1 corresponding to the second sensing pads 232, so that color shift caused when lights are passed through the first sensing pads 222 and the second sensing pads 232 can be compensated and accordingly the visual effect of the touch panel 200 can be improved.

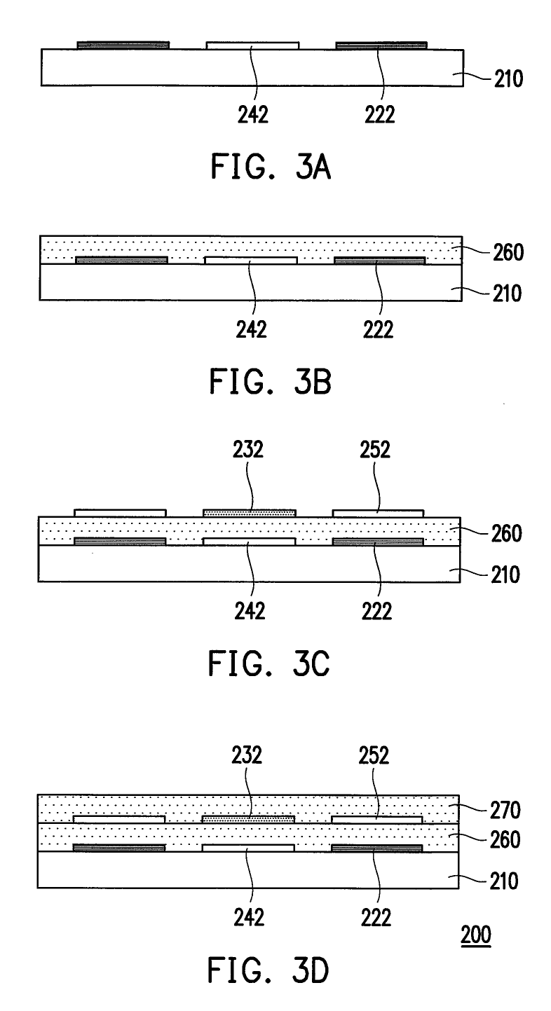

As shown in FIG. 2C, in the present embodiment, the touch panel 200 may further include a first dielectric layer 260 or even a second dielectric layer 270. A method for manufacturing the touch panel 200 having the dielectric layers 260 and 270 as illustrated in FIG. 2C is provided, and which will be explained with reference to FIGS. 2A-2C and 3A-3D.

First, as shown in FIGS. 2B and 3A, the first sensing pads 222, the first bridging lines 224, and the second dummy sensing pads 252 are formed on the substrate 210, wherein the first sensing pads 222 and the first bridging lines 224 are connected to each other in series so as to form the first sensing serial 220. To be specific, the first sensing pads 222, the first bridging lines 224, and the second dummy sensing pads 252 may be formed by the steps of forming a transmissive conductive material layer (for example, an indium tin oxide layer—ITO layer, not shown) on the substrate 210 first and then patterning the transmissive conductive material layer through an appropriate method.

Next, as shown in FIG. 3B, the first dielectric layer 260 is formed on the substrate 210 to cover the first sensing pads 222, the first bridging lines 224, and the second dummy sensing pads 252. The material of the first dielectric layer 260 may be silicon nitride, silicon oxide, or organic resin.

Thereafter, as shown in FIGS. 2A and 3C, the second sensing pads 232, the second bridging lines 234, and the first dummy sensing pads 242 are formed on the first dielectric layer 260, wherein the second sensing pads 232 and the second bridging lines 234 are connected to each other in series so as to form the second sensing serial 230. Similarly, the second sensing pads 232, the second bridging lines 234, and the first dummy sensing pads 242 may be formed by forming a transmissive conductive material layer (for example, an ITO layer, not shown) on the substrate 210 and then patterning the transmissive conductive material layer through an appropriate method. The first dummy sensing pads 242 are corresponding to the first sensing pads 222, and the second sensing pads 232 are corresponding to the second dummy sensing pads 252.

Next, as shown in FIG. 3D, the second dielectric layer 270 is formed on the first dielectric layer 260 to cover the second sensing pads 232, the second bridging lines 234, and the first dummy sensing pads 242. By now the touch panel 200 as shown in FIG. 2C is completed. The material of the second dielectric layer 270 may be silicon nitride, silicon oxide, or organic resin.

In the embodiment described above, the spaces between adjacent sensing pads and dummy sensing pads may cause difference in the transmittance of the touch panel and accordingly affect the visual effect of the entire touch panel. Accordingly, in the present invention, dummy patterns may be further disposed on these spaces in order to uniform the transmittance of the touch panel.

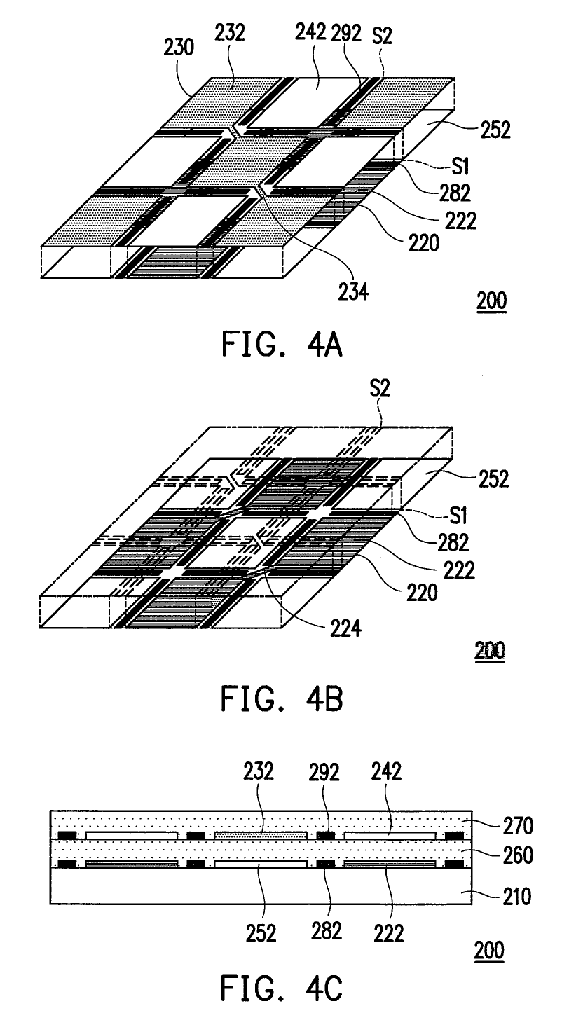

FIGS. 4A-4C illustrate a touch panel according to another embodiment of the present invention, wherein FIG. 4A is a 3-dimensional view of the touch panel, FIG. 4B is a perspective view of the touch panel, and FIG. 4C is a cross-sectional view of the touch panel. For the convenience of description, those like components as illustrated in FIGS. 4A-4C and FIGS. 2A-2C will not be described herein. In the present embodiment, a first dummy pattern 282 is further disposed between each first sensing pad 222 and the adjacent second dummy sensing pad 252, and a second dummy pattern 292 is further disposed between each second sensing pad 232 and the adjacent first dummy sensing pad 242. The first dummy patterns 282 and the second dummy patterns 292 may be in strip shape.

The first dummy patterns 282 may be fabricated together with the first sensing pads 222, the first bridging lines 224, and the second dummy sensing pads 252, namely, they are formed by patterning the same transmissive conductive material layer. In addition, the second dummy patterns 292 may be fabricated together with the second sensing pads 232, the second bridging lines 234, and the first dummy sensing pads 242, namely, they are formed by patterning another transmissive conductive material layer.

In the embodiment described above, dummy patterns are disposed between adjacent sensing pads (or dummy sensing pads) in order to improve the transmittance uniformity of the entire touch panel and accordingly the visual effect thereof. Moreover, openings may be formed in the sensing pads and dummy sensing pads to form hollow portions therein so that the visual effect of the touch panel, and accordingly the transmittance thereof, can be further improved. This will be described below with reference to FIG. 16.

In other embodiments of the present invention, the sensing pads may also be formed on the same plane, namely, the sensing pads may be coplanar, so as to form a touch panel having a single-layered sensing pad structure, and various patterns for connecting the sensing pads in different directions are provided. Since the sensing pads are coplanar, the problem of color shift is avoided and the display uniformity of the entire touch panel is improved.

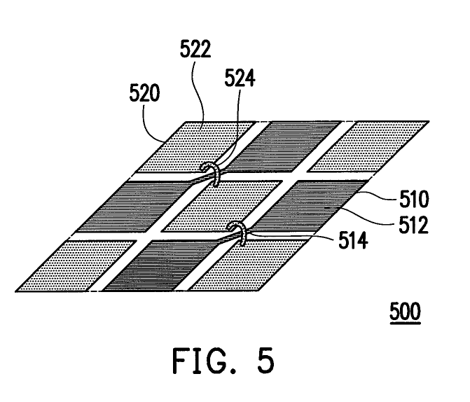

FIG. 5 illustrates a single-layered sensing pad structure of a touch panel according to an embodiment of the present invention. The single-layered sensing pad structure 500 may be constructed on the substrate (not shown) in foregoing embodiment, and the single-layered sensing pad structure 500 includes a first sensing serial 510 and a second sensing serial 520 which are coplanar. The numbers of the first sensing serial 510 and the second sensing serial 520 may be one or multiple according to the actual requirement (for example, the size of the touch panel), and the first sensing serial 510 and the second sensing serial 520 are respectively extended along two different directions, wherein the two directions intersect each other. The first sensing serial 510 includes a plurality of first sensing pads 512 and a plurality of first bridging lines 514, wherein each of the first bridging lines 514 connects adjacent two first sensing pads 512 in series. The second sensing serial 520 includes a plurality of second sensing pads 522 and a plurality of second bridging lines 524, wherein each of the second bridging lines 524 connects adjacent two second sensing pads 522 in series. The first sensing pads 512 and the second sensing pads 522 are coplanar, namely, the first sensing pads 512 and the second sensing pads 522 are located on the same plane.

Various touch panels having foregoing single-layered sensing pad structure and the manufacturing methods thereof will be described below. However, it should be understood by those skilled in the art that changes in forms and details may be made therein without departing the spirit and scope of the present invention.

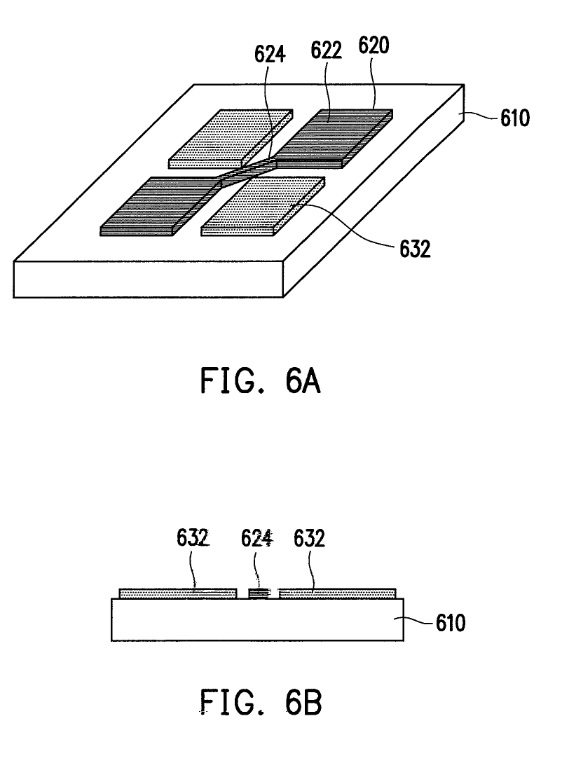

FIGS. 6A-6B, 7A-7B, and 8A-8C illustrate a manufacturing method of a touch panel having a single-layered sensing pad structure according to an embodiment of the present invention. First, referring to FIGS. 6A and 6B, a plurality of first sensing pads 622, a plurality of first bridging lines 624, and a plurality of second sensing pads 632 are formed on a substrate 610, wherein each of the first bridging lines 624 connects adjacent two first sensing pads 622 in series so as to form a first sensing serial 620. As described in foregoing embodiment, the first sensing pads 622, the first bridging lines 624, and the second sensing pads 632 may be formed by forming a transmissive conductive material layer (for example, an ITO layer, not shown) on the substrate 610 first and then patterning the transmissive conductive material layer through an appropriate method. The first sensing pads 622 and the second sensing pads 632 are coplanar, namely, the first sensing pads 622 and the second sensing pads 632 are located on the same plane (the substrate 610).

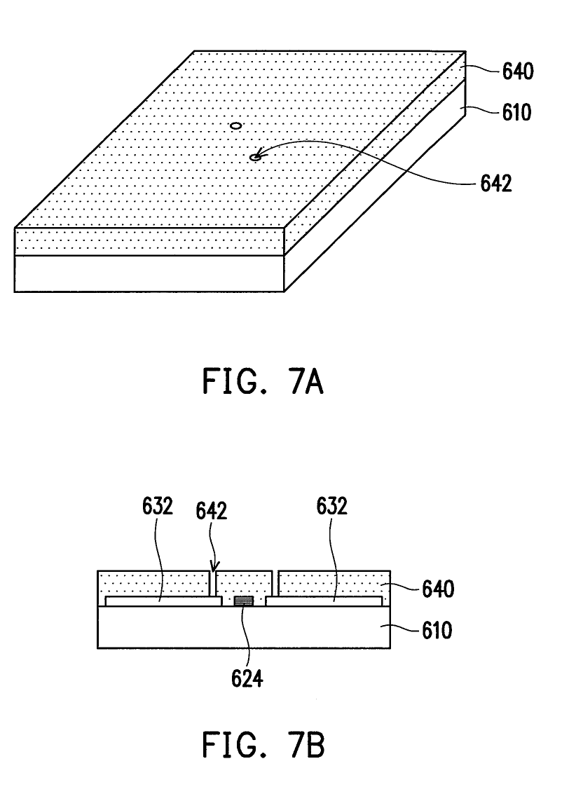

Next, referring to FIGS. 7A and 7B, a first dielectric layer 640 is formed on the substrate 610, and a plurality of openings or via holes 642 are formed in the first dielectric layer 640. The via holes 642 are corresponding to the second sensing pads 632 and expose parts of the corresponding second sensing pads 632. The material of the first dielectric layer 640 may be silicon nitride, silicon oxide, or organic resin.

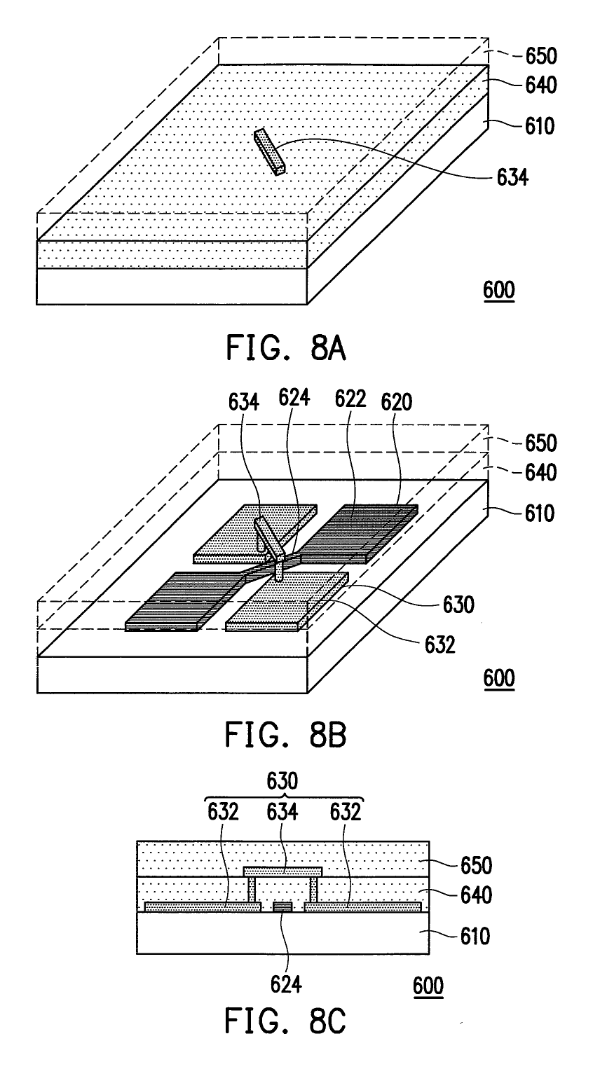

Thereafter, referring to FIGS. 8A-8C, a plurality of second bridging lines 634 are formed on the first dielectric layer 640, and the second bridging lines 634 are connected to the corresponding second sensing pads 632 through the corresponding via holes 642 so as to form a second sensing serial 630. The second bridging lines 634 may be made by a conductive material layer (for example, a metal layer, not shown) or a transmissive conductive material layer (for example, an ITO layer, not shown) on the first dielectric layer 640 first and then patterning the transmissive conductive material layer through an appropriate method. In the present embodiment, a second dielectric layer 650 may be further formed on the first dielectric layer 640 to cover the second bridging lines 634. The material of the second dielectric layer 650 may be silicon nitride, silicon oxide, or organic resin.

By now, the fabrication of a touch panel 600 is completed. In order to illustrate the structure of the touch panel 600 clearly, the second dielectric layer 650 in FIG. 8A is denoted with dotted lines, and the first dielectric layer 640 in FIG. 8B is also denoted with dotted lines. FIG. 8C is a cross-sectional view of the touch panel 600.

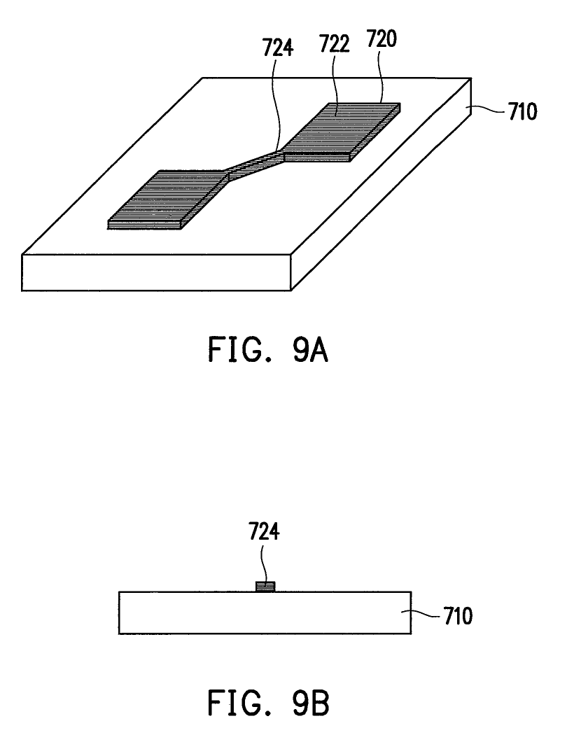

FIGS. 9A-9B, 10A-10B, and 11A-11C illustrate a manufacturing method of a touch panel having a single-layered sensing pad structure according to another embodiment of the present invention. First, referring to FIGS. 9A and 9B, a plurality of first sensing pads 722 and a plurality of first bridging lines 724 are formed on a substrate 710, wherein each of the first bridging lines 724 connects adjacent two first sensing pads 722 in series so as to form a first sensing serial 720. As described in foregoing embodiment, the first sensing pads 722 and the first bridging lines 724 may be formed by forming a transmissive conductive material layer (for example, an ITO layer, not shown) on the substrate 710 first and then patterning the transmissive conductive material layer through an appropriate method.

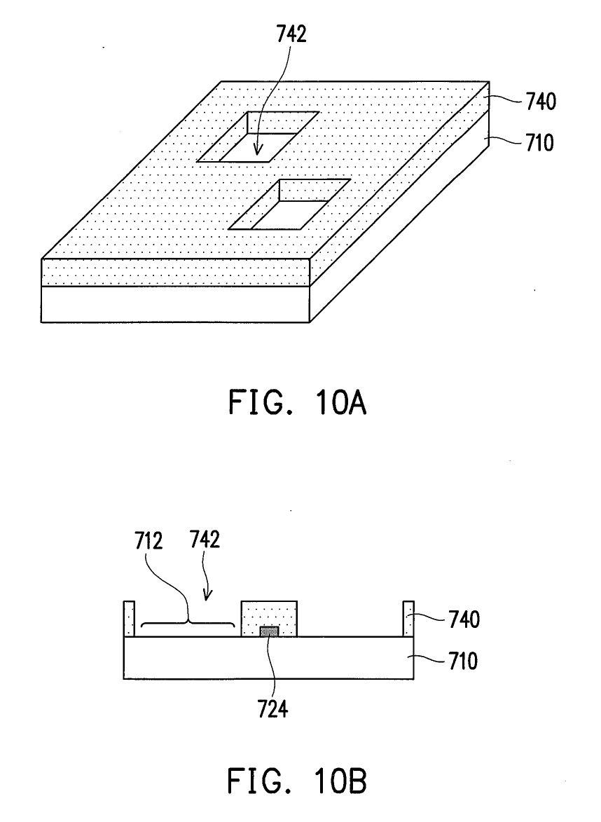

Next, referring to FIGS. 10A and 10B, a first dielectric layer 740 is formed on the substrate 710, and a plurality of openings 742 are formed in the first dielectric layer 740. The openings 742 expose a plurality of areas 712 of the substrate 710. The material of the first dielectric layer 740 may be silicon nitride, silicon oxide, or organic resin.

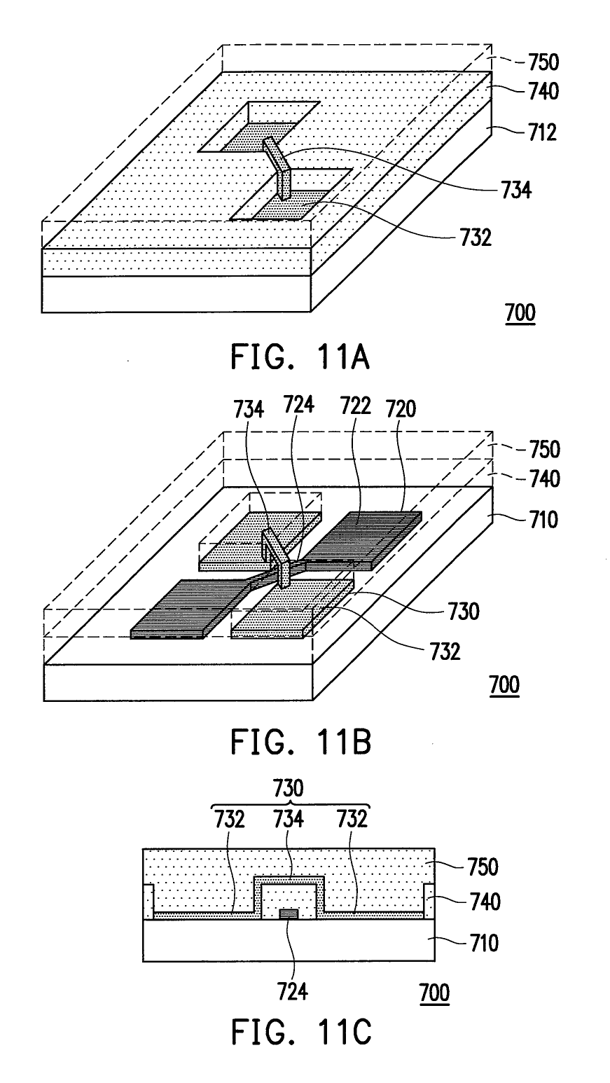

Thereafter, referring to FIGS. 11A-11C, a plurality of second sensing pads 732 and a plurality of second bridging lines 734 are formed so as to form a second sensing serial 730. The second sensing pads 732 are formed on the areas 712 in the corresponding openings 742 to be coplanar to the first sensing pads 722, and each of the second bridging lines 734 spans over the first dielectric layer 740 between adjacent two openings 742 to connect corresponding adjacent two second sensing pads 732. To be specific, in the present embodiment, a transmissive conductive material layer (for example, an ITO layer, not shown) may be formed on the first dielectric layer 740 through a thin film deposition process, wherein because the first dielectric layer 740 has the openings 742, parts of the transmissive conductive material layer will be formed on the areas 712 in the openings 742. After that, the transmissive conductive material layer may be patterned so as to form the second sensing pads 732 and the second bridging lines 734. Additionally, in the present embodiment, a second dielectric layer 750 may be further formed on the first dielectric layer 740 to cover the second sensing pads 732 and the second bridging lines 734. The material of the second dielectric layer 750 may be silicon nitride, silicon oxide, or organic resin.

By now, the fabrication of a touch panel 700 is completed. In order to illustrate the structure of the touch panel 700 clearly, the second dielectric layer 750 in FIG. 11A is denoted with dotted lines, and the first dielectric layer 740 in FIG. 11B is also denoted with dotted lines. FIG. 11C is a cross-sectional view of the touch panel 700.

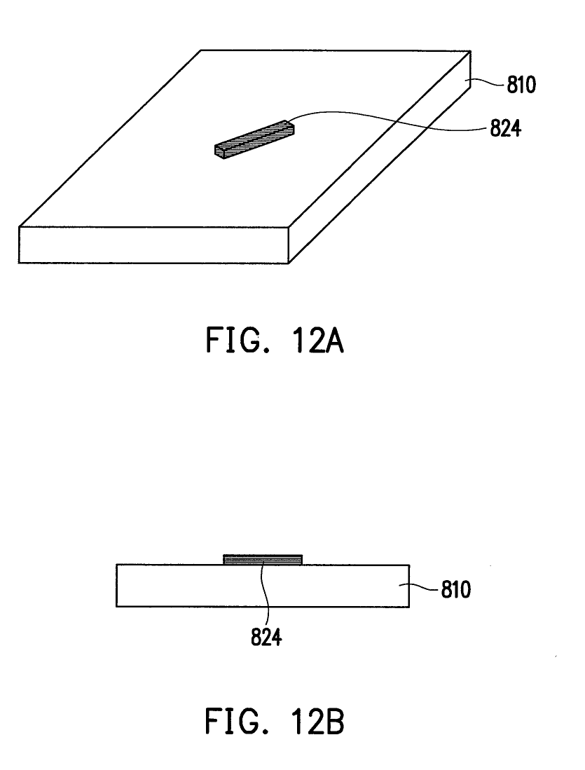

FIGS. 12A-12B, 13A-13B, and 14A-14C illustrate a manufacturing method of a touch panel having a single-layered sensing pad structure according to yet another embodiment of the present invention. First, referring to FIGS. 12A and 12B, a plurality of first bridging lines 824 are formed on a substrate 810. As described in foregoing embodiment, the first bridging lines 824 may be made by a conductive material layer (for example, a metal layer, not shown) or a transmissive conductive material layer (for example, an ITO layer, not shown) on the substrate 810 first and then pattering the transmissive conductive material layer through an appropriate method.

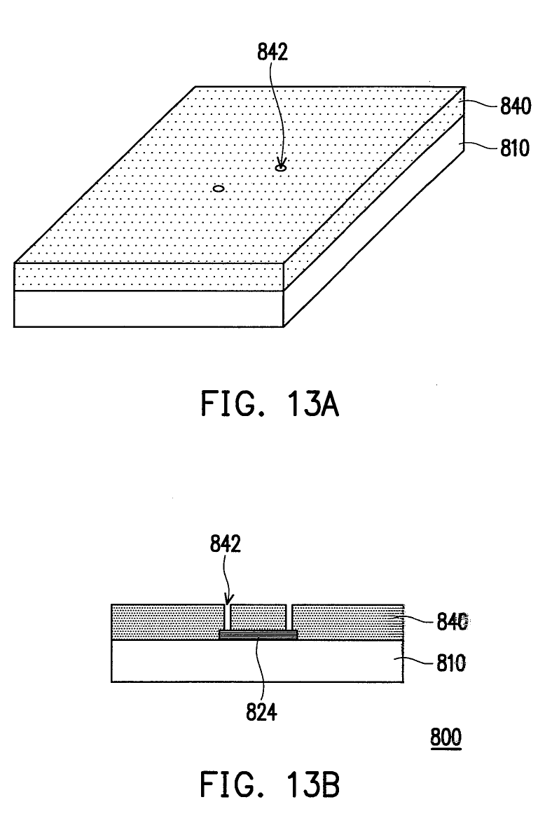

Next, referring to FIGS. 13A and 13B, a first dielectric layer 840 is formed on the substrate 810, and a plurality of via holes 842 are formed in the first dielectric layer 840. The via holes 842 may expose two ends of the corresponding first bridging lines 824. The material of the first dielectric layer 840 may be silicon nitride, silicon oxide, or organic resin.

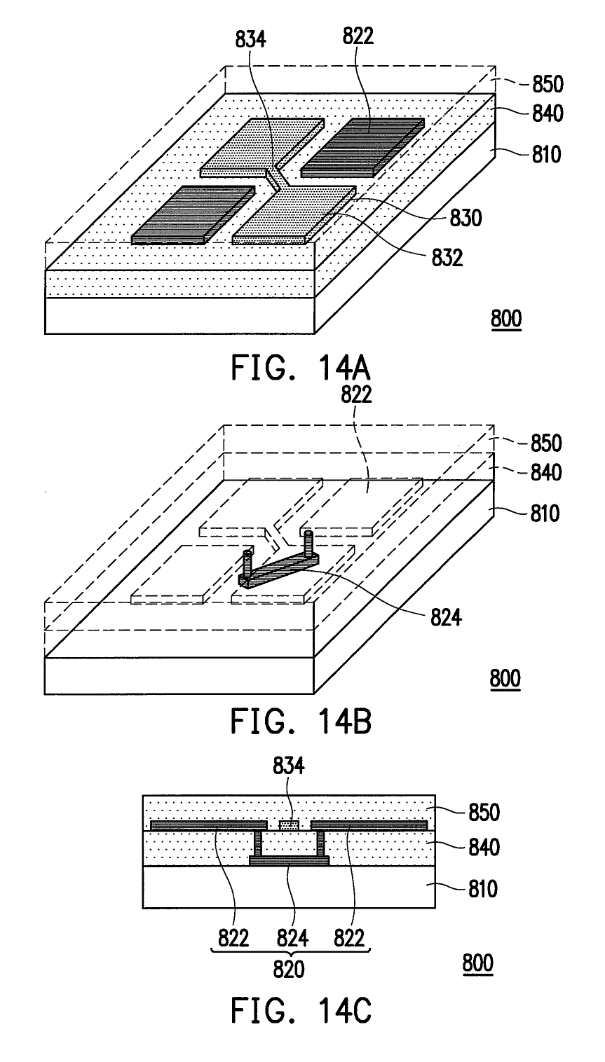

After that, referring to FIGS. 14A-14C, a plurality of first sensing pads 822, a plurality of second sensing pads 832, and a plurality of second bridging lines 834 are formed on the first dielectric layer 840, wherein the second sensing pads 832 and the second bridging lines 834 form a second sensing serial 830. The first sensing pads 822 are connected to the corresponding first bridging lines 824 through the corresponding via holes 842 so as to form a first sensing serial 820. Similarly, in the present embodiment, the first sensing pads 822, the second sensing pads 832, and the second bridging lines 834 may be formed by forming a transmissive conductive material layer (for example, an ITO layer, not shown) on the first dielectric layer 840 through a thin film deposition process first and then patterning the transmissive conductive material layer through an appropriate method. Additionally, in the present embodiment, a second dielectric layer 850 may be further formed on the first dielectric layer 840 to cover the second sensing pads 832 and the second bridging lines 834. The material of the second dielectric layer 850 may be silicon nitride, silicon oxide, or organic resin. The first sensing pads 822 and the second sensing pads 832 are coplanar, namely, the first sensing pads 822 and the second sensing pads 832 are located on the same plane (the first dielectric layer 840).

By now, the fabrication of a touch panel 800 is completed. In order to illustrate the structure of the touch panel 800 clearly, the second dielectric layer 850 in FIG. 14A is denoted with dotted lines, and the first dielectric layer 840 in FIG. 14B is also denoted with dotted lines. FIG. 14C is a cross-sectional view of the touch panel 800.

In foregoing embodiment, the spaces between the coplanar first sensing pads and second sensing pads may cause difference in the transmittance of the touch panel and accordingly affect the visual effect thereof. Thus, in the present invention, dummy patterns may be further disposed on these spaces in order to uniform the transmittance of the touch panel.

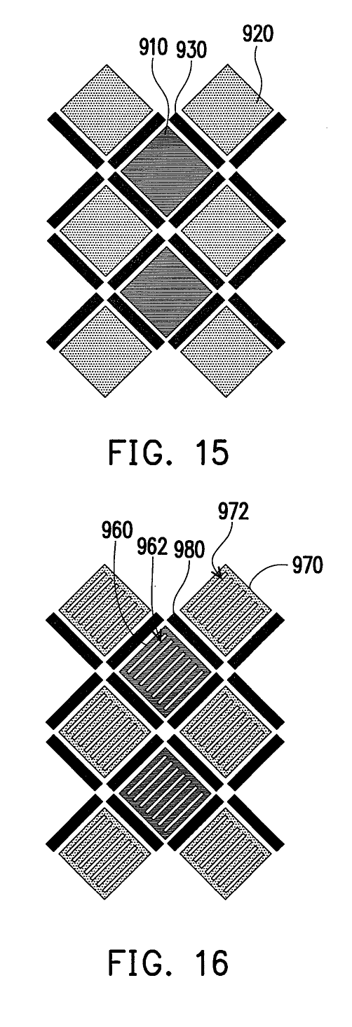

FIG. 15 illustrates a touch panel and the relative positions of sensing pads and dummy patterns thereof according to an embodiment of the present invention. It should be noted that this disposition pattern can be applied to each embodiment described above, and to simply the illustration, the bridging lines between the sensing pads are skipped in FIG. 15, and the connections thereof can be referred to the descriptions of foregoing embodiments therefore will not be described herein. As shown in FIG. 15, a dummy pattern 930 is disposed between each first sensing pad 910 and an adjacent second sensing pad 920. As described above, the dummy patterns 930 may be fabricated together with the first sensing pads 910 or the second sensing pads 920 to be coplanar to the first sensing pads 910 and the second sensing pads 920. In the present embodiment, the dummy patterns 930 may be in strip shape.

According to the present invention, besides disposing dummy patterns between adjacent sensing pads (or dummy sensing pads) to uniform the transmittance of a touch panel, openings may also be formed on the sensing pads to form some hollow portions so that the visual effect of the touch panel and accordingly the transmittance thereof can be further improved.

FIG. 16 illustrates a touch panel according to another embodiment of the present invention, wherein the sensing pads of the touch panel are disposed with openings. The first sensing pads 960 and the second sensing pads 970 respectively have at least one opening 962 and at least one opening 972 to form a hollow portion, and the openings may be formed together with the first sensing pads 960 and the second sensing pads 970 or formed by patterning the first sensing pads 960 and the second sensing pads 970 after they are formed. The openings 962 and 972 can improve the uniformity and transmittance of the entire touch panel and reduce the color shift thereof. In particular, if the touch panel is integrated with a display panel, the openings 962 and 972 on the first sensing pads 960 and the second sensing pads 970 may be disposed corresponding to the display pixel areas on the display panel so as to improve the brightness of a displayed image. Moreover, as described in foregoing embodiments, in the present embodiment, a dummy pattern 980 may be further disposed between each first sensing pad 960 and the adjacent second sensing pad 970, wherein the dummy pattern 980 may be in strip shape.

In summary, the present invention provides a touch panel having a double-layered sensing pad structure or a single-layered sensing pad structure, wherein both the visual effect and the transmittance of the touch panel are improved through some special designs of the sensing pads and the dispositions thereof and some dummy patterns disposed additionally or by forming openings in the sensing pads. The detailed structure, manufacturing method, and functions of the touch panel have all been described in foregoing embodiments.

In actual applications, the touch panel provided by the present invention can be integrated with various display devices, such as liquid crystal display (LCD) panels, organic light-emitting diode (OLED) panels, or conventional cold cathode ray tube (CRT) screens, in order to allow users to operate these display devices by touching the displays. The touch panel provided by the present invention can be manufactured separately, or the manufacturing thereof can also be integrated with the fabrication process of foregoing display panels. For example, the manufacturing of a touch panel in the present invention can be integrated with a process for fabricating a color filter in a LCD panel by fabricating the color filter and the touch panel on the same substrate. Those skilled in the art should be able to apply or integrate the present invention to various fields according to the present disclosure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a substrate;
at least one first sensing serial, disposed on the substrate and extended along a first direction, wherein the first sensing serial comprises:
a plurality of first sensing pads; and
a plurality of first bridging lines, wherein each of the first bridging lines connects adjacent two first sensing pads in series;
at least one second sensing serial, disposed on the substrate and extended along a second direction, wherein the first direction intersects the second direction, and the second sensing serial comprises:
a plurality of second sensing pads, being coplanar to the first sensing pads; and
a plurality of second bridging lines, wherein each of the second bridging lines connects adjacent two second sensing pads in series.

2. The touch panel according to claim 1 further comprising:
a first dielectric layer, disposed on the substrate and covering the first sensing serial and the second sensing pads, wherein the second bridging lines are located on the first dielectric layer; and
a plurality of via holes, disposed in the first dielectric layer, wherein the second bridging lines are connected to the corresponding second sensing pads through the corresponding via holes.

3. The touch panel according to claim 2 further comprising a second dielectric layer disposed on the first dielectric layer and covering the first sensing serial and the second sensing serial.

4. The touch panel according to claim 1 further comprising a first dielectric layer disposed on the substrate and covering the first sensing serial, wherein the first dielectric layer has a plurality of openings corresponding to the second sensing pads, the second sensing pads are located in the corresponding openings, and each of the second bridging lines spans over the first dielectric layer between adjacent two openings to connect the corresponding adjacent two second sensing pads.

5. The touch panel according to claim 4 further comprising a second dielectric layer disposed on the first dielectric layer and covering the first sensing serial and the second sensing serial.

6. The touch panel according to claim 1 further comprising:
a first dielectric layer, disposed on the substrate and covering the first bridging lines, wherein the first sensing pads and the second sensing serial are located on the first dielectric layer; and
a plurality of via holes, disposed in the first dielectric layer, wherein the first sensing pads are connected to the corresponding first bridging lines through the corresponding via holes.

7. The touch panel according to claim 6 further comprising a second dielectric layer disposed on the first dielectric layer and covering the first sensing serial and the second sensing serial.

8. The touch panel according to claim 1 further comprising a plurality of dummy patterns, wherein each of the dummy patterns is located between one of the first sensing pads and one of the second sensing pads adjacent to the first sensing pad.

9. The touch panel according to claim 1, wherein each of the first sensing pads and each of the second sensing pads respectively have at least one opening.

10. The touch panel according to claim 9, wherein the at least one opening of the first sensing pad or the second sensing pad comprises a trellis pattern or a plurality of strip patterns.

11. A touch panel, comprising:
a substrate;
at least one first sensing serial, disposed on the substrate and extended along a first direction, wherein the first sensing serial comprises:
a plurality of first sensing pads; and
a plurality of first bridging lines, wherein each of the first bridging lines connects adjacent two first sensing pads in series;
a plurality of second dummy sensing pads, disposed on the substrate;
a first dielectric layer, disposed on the substrate and covering the first sensing serial and the second dummy sensing pads;
at least one second sensing serial, disposed on the first dielectric layer and extended along a second direction, wherein the first direction intersects the second direction, and the second sensing serial comprises:
a plurality of second sensing pads, corresponding to the second dummy sensing pads; and
a plurality of second bridging lines, wherein each of the second bridging lines connects adjacent two second sensing pads in series;
a plurality of first dummy sensing pads, disposed on the first dielectric layer and corresponding to the first sensing pads; and
a second dielectric layer, disposed on the first dielectric layer and covering the second sensing serial and the first dummy sensing pads.

12. The touch panel according to claim 11 further comprising a plurality of first dummy patterns, wherein each of the first dummy patterns is located between one of the first sensing pads and one of the second dummy sensing pads adjacent to the first sensing pad.

13. The touch panel according to claim 11 further comprising a plurality of second dummy patterns, wherein each of the second dummy patterns is located between one of the first dummy sensing pads and one of the second sensing pads adjacent to the first dummy sensing pad.

14. A manufacturing method of a touch panel, comprising:
providing a substrate;
forming at least one first sensing serial on the substrate, the first sensing serial being disposed on the substrate and extended along a first direction, wherein the first sensing serial comprises a plurality of first sensing pads and a plurality of first bridging lines, and each of the first bridging lines connects adjacent two first sensing pads in series; and
forming at least one second sensing serial on the substrate, the second sensing serial being disposed on the substrate and extended along a second direction, wherein the first direction intersects the second direction, and the second sensing serial comprises a plurality of second sensing pads and a plurality of second bridging lines, the second sensing pads and the first sensing pads are coplanar, and each of the second bridging lines connects adjacent two second sensing pads in series.

15. The manufacturing method according to claim 14, wherein the first sensing pads, the first bridging lines, and the second sensing pads are formed on the substrate first to make the first sensing pads, the first bridging lines, and the second sensing pads to be coplanar, and then the manufacturing method further comprises:
forming a first dielectric layer on the substrate to cover the first sensing pads, the first bridging lines, and the second sensing pads; and
forming a plurality of via holes in the first dielectric layer and then forming the second bridging lines on the first dielectric layer, wherein the second bridging lines are connected to the corresponding second sensing pads through the corresponding via holes.

16. The manufacturing method according to claim 15 further comprising forming a second dielectric layer on the first dielectric layer to cover the first sensing serial and the second sensing serial.

17. The manufacturing method according to claim 14, wherein after forming the first sensing serial on the substrate, the manufacturing method further comprises:
forming a first dielectric layer on the substrate to cover the first sensing serial; and
forming a plurality of openings in the first dielectric layer and then forming the second sensing serial, wherein the second sensing pads of the second sensing serial are formed in the corresponding openings to be coplanar to the first sensing pads, and each of the second bridging lines of the second sensing serial spans over the first dielectric layer between adjacent two openings to connect the corresponding adjacent two second sensing pads.

18. The manufacturing method according to claim 17 further comprising forming a second dielectric layer on the first dielectric layer to cover the first sensing serial and the second sensing serial.

19. The manufacturing method according to claim 14, wherein after forming the first bridging lines on the substrate, the manufacturing method further comprises:
forming a first dielectric layer on the substrate to cover the first bridging lines; and
forming a plurality of via holes in the first dielectric layer and then forming the first sensing pads and the second sensing serial on the first dielectric layer, wherein the first sensing pads, the second sensing pads, and the second bridging lines are coplanar, and the first sensing pads are connected to the corresponding first bridging lines through the corresponding via holes.

20. The manufacturing method according to claim 19 further comprising forming a second dielectric layer on the first dielectric layer to cover the first sensing serial and the second sensing serial.

21. The manufacturing method according to claim 14 further comprising forming a plurality of dummy patterns while forming the first sensing pads or the second sensing pads, wherein each of the dummy patterns is located between one of the first sensing pads and one of the second sensing pads adjacent to the first sensing pad.

22. The manufacturing method according to claim 14, wherein each of the first sensing pads and each of the second sensing pads respectively have at least one opening.

23. A manufacturing method of a touch panel, comprising:
providing a substrate;
forming a plurality of first sensing pads, a plurality of first bridging lines, and a plurality of second dummy sensing pads on the substrate, wherein each of the first bridging lines connects adjacent two first sensing pads in series so as to form at least one first sensing serial, and the first sensing serial is extended along a first direction;
forming a first dielectric layer on the substrate to cover the first sensing pads, the first bridging lines, and the second dummy sensing pads;
forming a plurality of second sensing pads, a plurality of second bridging lines, and a plurality of first dummy sensing pads on the first dielectric layer, wherein each of the second bridging lines connects adjacent two second sensing pads in series so as to form at least one second sensing serial, and the second sensing serial is extended along a second direction, the second direction intersects the first direction, the first dummy sensing pads are corresponding to the first sensing pads, and the second sensing pads are corresponding to the second dummy sensing pads; and
forming a second dielectric layer on the first dielectric layer to cover the second sensing pads, the second bridging lines, and the first dummy sensing pads.

24. The manufacturing method according to claim 23 further comprising forming a plurality of first dummy patterns while forming the first sensing pads, the first bridging lines, and the second dummy sensing pads, wherein each of the first dummy patterns is located between one of the first sensing pads and one of the second dummy sensing pads adjacent to the first sensing pad.

25. The manufacturing method according to claim 23 further comprising forming a plurality of second dummy patterns while forming the second sensing pads, the second bridging lines, and the first dummy sensing pads, wherein each of the second dummy patterns is located between one of the second sensing pads and one of the first dummy sensing pads adjacent to the second sensing pad.
